(19) United States
(12) Patent Application Publication
(10) Pub. No.: US 2018/0018923 A1
(43) Pub. Date: Jan. 18, 2018

(54) LIQUID CRYSTAL DISPLAY AND METHOD FOR LOWERING POWER CONSUMPTION OF LIQUID CRYSTAL DISPLAY

(71) Applicant: Wuhan China Star Optoelectronics Technology Co., Ltd., Wuhan (CN)

(72) Inventors: Qingcheng ZUO, Shenzhen (CN); Xiaoling YUAN, Shenzhen (CN)

(73) Assignee: Wuhan China Star Optoelectronics Technology Co., Ltd., Wuhan (CN)

(21) Appl. No.: 15/297,087

(22) Filed: Oct. 18, 2016

(30) Foreign Application Priority Data
Jul. 12, 2016 (CN) 201610543137.0

(51) Int. Cl. G09G 3/34; G09G 3/36

(52) U.S. Cl. CPC G09G 3/342; G09G 3/36; G09G 2330/021; G09G 2320/0626

(57) ABSTRACT

The present disclosure provides a method for lowering power consumption of liquid crystal display, wherein includes: calculating an average brightness of all pixels when displaying the image; comparing the average brightness with a preset brightness; determining whether at least one string in the multi-string LED light string in parallel is turned off according to the comparison result. The present disclosure further discloses a liquid crystal display using the method for reducing the power consumption of the liquid crystal display. The present disclosure can reduce the power consumption of the backlight module to achieve the power saving effect without affecting the screen display effect.

### FIELD OF THE DISCLOSURE

The present disclosure relates to a liquid crystal display technology field, and more particularly to a liquid crystal display and a method for lowering power consumption of liquid crystal display.

### BACKGROUND OF THE DISCLOSURE

With the evolution of the optical and semiconductor technology, but also led to the vigorous development of flat panel displays, in many flat panel displays, since the liquid crystal display has the superior characteristics of high space efficiency, low power consumption, no radiation and low electromagnetic interference, have been used in all aspects of production and life.

The liquid crystal display generally includes a liquid crystal panel and a backlight module providing the uniform light to the liquid crystal panel arranged in opposing relation. In the electronic equipment with liquid crystal display (such as a mobile phone, a tablet computer, etc.), the largest part of the power consumption is part of the backlight module. Therefore, how to reduce the power consumption of the backlight module is an urgent need to address the technical problems.

### SUMMARY OF THE DISCLOSURE

In order to solve the above-mentioned problems in the prior art, the present disclosure provides a liquid crystal display and a method for lowering the power consumption of the liquid crystal display.

According to an aspect of the present disclosure, there is provided a method of lowering power consumption of the liquid crystal display, the method includes: calculating an average brightness of all pixels when displaying the image; comparing the average brightness with a preset brightness; determining whether at least one string in the multi-string LED light string in parallel is turned off according to the comparison result.

Optionally, if the average brightness is less than the preset brightness, turning off at least one string of the multi-string LED light string in parallel.

Optionally, after turning off the at least one string of the multi-string LED light string in parallel, increasing the current of the LED light string that is not turned off so that the brightness of the unblocked LED light string provided is satisfied the brightness of all pixels displaying the image required.

Optionally, the method of increasing the current of the unblocked LED light string includes: determining the current of the unblocked LED light string required according to the brightness of all pixels displaying image required; outputting a control signal according to the current of the unblocked LED light string required; increasing the current of the unblocked LED light string according to the outputted control signal, so that the current of the unblocked LED light string reaches the required current.

Optionally, if the average brightness is not less than the preset brightness, adjusting the current of each LED light string, so that the brightness of the multi-string LED light string in parallel provided is satisfied the brightness of all pixels displaying image required.

According to another aspect of the present disclosure, there is provided a liquid crystal display, includes a liquid crystal panel and a backlight module arranged in opposing relation, the liquid crystal panel includes a plurality of pixels and a control chip, the backlight module includes the multi-string LED light string in parallel and a controller used to control the LED light string, the control chip is used to receive an image data from an external system, the plurality of pixels is used to display image based on the image data and provided by the multi-string LED light string in parallel, when the plurality of pixels displaying image, the control chip is further used to calculate the average brightness when the plurality of pixels displaying image, and further comparing the average brightness with the preset brightness; the controller is further used to determine whether at least one string in the multi-string LED light string in parallel is turned off according to the comparison result.

Optionally, if the average brightness is less than the preset brightness, the controller is further used to turn off at least one string in the multi-string LED light string in parallel.

Optionally, the controller is further used to increase the current of the unblocked LED light string, so that the brightness of the unblocked LED light string provided is satisfied the brightness of all pixels displaying image required.

Optionally, the control chip is further used to determine the current of the unblocked LED light string required according to the brightness of all pixels displaying image required, and is further used to output the control signal according to the current of the unblocked LED light string required; the controller is further used to increase the current of the unblocked LED light string according to the outputted control signal, so that the current of the unblocked LED light string reaches the required current.

Optionally, if the average brightness is not less than the preset brightness, the controller is further used to adjust the current of each LED light string, so that the brightness of the multi-string LED light string in parallel provided is satisfied the brightness of all pixels displaying image required.

The present disclosure can reduce the power consumption of the backlight module to achieve the power saving effect without affecting the screen display effect.

### BRIEF DESCRIPTION OF THE DRAWINGS

The following description in conjunction with the accompanying drawings, the above and other aspects, features and advantages of the embodiments of the present disclosure will become more apparent from the accompanying drawings in

FIG. 1 is a schematic diagram of the liquid crystal display of the embodiment of the present disclosure;

FIG. 2 is a flow chart of the method for lowering power consumption of liquid crystal display of the embodiment of the present disclosure.

### DETAILED DESCRIPTION OF PREFERRED EMBODIMENTS

Hereinafter, embodiments of the present disclosure will be described in detail with reference to the accompanying drawings. However, in many different forms and embodiments of the present disclosure, and the disclosure should not be construed as limited to the specific embodiments set forth herein. Rather, these embodiments are provided to explain the principles of the disclosure and its practical application, thereby others skilled in the art to understand the disclosure for various embodiments and various modifications suited to the particular intended application.

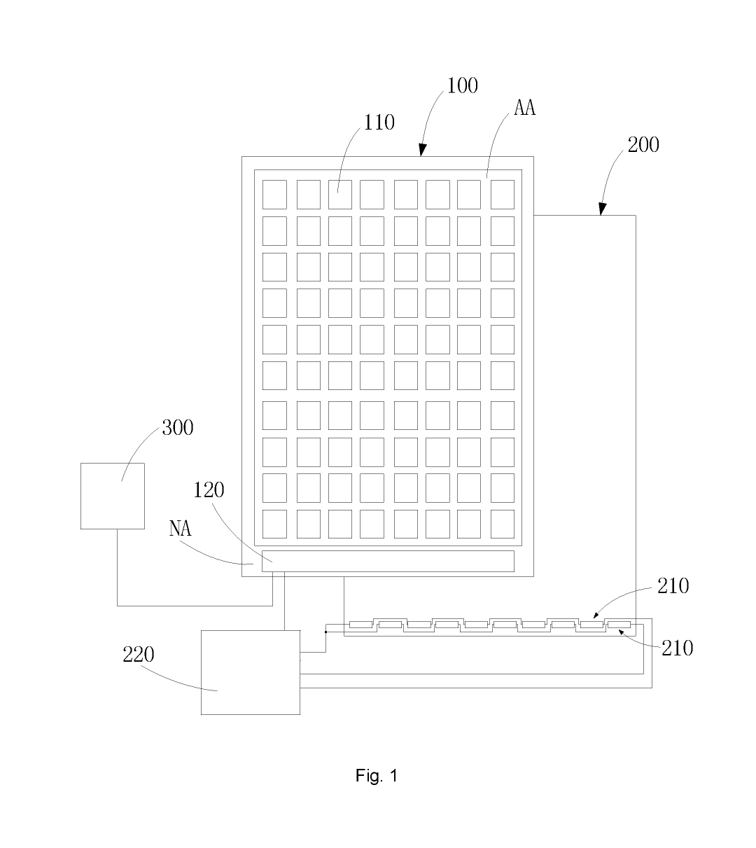

FIG. 1 is a schematic diagram of the liquid crystal display of the embodiment of the present disclosure.

Refer to FIG. 1, the liquid crystal display of the embodiment of the present disclosure includes a liquid crystal panel 100 and a backlight module 200 arranged in opposing relation, wherein, the backlight module 200 provides the uniform display light to the liquid crystal panel 100.

The liquid crystal panel 100 is generally divided into a display area AA and a non-display area NA located around the display area AA and surrounding the display area AA. A plurality of pixels 110 having an array arrangement in the display area AA and a control chip (IC) 120 in one of the non-display areas NA. The control chip 120 receives the image data from the external system 300, herein, the external system 300 refers to a control system of an electronic device (such as a mobile phone, a tablet computer, etc.) having a liquid crystal display.

The backlight module 200 includes two LED 210 strings in parallel and a controller 220 (such as a PWM controller) for controlling the LED light string 210. In the FIG. 1, for ease of illustration, the controller 220 is not placed in the backlight module 200. It should be understood that, in practice, the controller 220 is typically included in the backlight module 200. It is to be noted that the present disclosure does not specifically limit the number of the LED strings 210.

In the present embodiment, the plurality of pixels 110 displaying image based on the received image data and provided by the two LED light strings 210 in parallel (i.e. the brightness of the light).

In the present embodiment, when the pixels 110 displaying image, the control chip 120 is configured to calculate the average brightness when the pixels 110 displaying image, and comparing the average brightness. Here, the average brightness refers to a ratio of the sum of the brightness when each pixel 110 displays an image to the number of all pixels 110. The controller 220 is configured to determine whether one of the two LED light string 210 in parallel is turned off according to the comparison result. Here, when the number of the LED light string 210 is three or more, the controller 220 determines whether at least one LED light string 210 in the multi-string LED light string 210 in parallel is turned off according to the comparison result.

In the present embodiment, the control chip 120 is further configured to compare the average brightness with the preset brightness. If the average brightness is less than the preset brightness, the controller 220 is configured to turn off one of the LED light string 210 of the two LED light strings 210 in parallel according to the comparison result of the average brightness less than the preset brightness.

After turn off one of the LED light string 210 of the two LED light string 210 in parallel, the control chip 120 is further configured to determine the current of the unblocked LED light string 210 required according to the brightness of the plurality of pixels 110 displaying image required, here, the current of the unblocked LED light string 210 required is more than the current when both LED light strings are turned on. That is, it is desirable to increase the current of the unblocked LED light string 210 so that the brightness provided by the unblocked LED light string 210 is satisfied the brightness required for multiple pixels 110 to display the image.

Further, the control chip 120 is further configured to find the corresponding control signal from the lookup table of the external system 300 based on the determined current of the unblocked LED light string 210 required, and to output the control signal to the controller 220. In the present embodiment, the control signal may be, for example, a logic level signal. The controller 220 is further configured to increase the current of the unblocked LED light string 210 controlled by the outputted control signal, so that the current of the unblocked LED light string 210 reaches the required current. Here, since the duty ratio of the detected control signal is increased, increasing the current of the unblocked LED light string 210 by the controller 220 according to the control signal in which the duty ratio is increased.

For example, if using the traditional method of brightness control, when the value of the average picture level (APL) is lower, e.g. the APL value is less than 15, the current of each LED light string 210 is reduced to 3.0 mA, the voltage of each LED light string 210 is about 20.8V (here, it is assumed that each LED light string 210 includes eight LEDs, the voltage of each LEDs is about 2.6V), at this time the backlight brightness is 3000 mcd, the total power consumption of the backlight can be calculated: 3.0 mA×20.8V+3.0 mA×20.8V=124.8 mW.

And using the brightness control method disclosed in the present embodiment, when the average brightness is less than the preset brightness (i.e. the APL value is less than 15), the control chip 120 turns off one of the LED light string 210 of the two LED light strings in parallel 210, while the other LED light string 210 still glows. Next, the control chip 120 increases the current of the unblocked LED light string 210 to 4.8 mA, at this time the backlight brightness is 3000 mcd, the voltage of the unblocked LED light string 210 is about 21.6V (here, it is assumed that each LED light string 210 includes eight LEDs, the voltage of each LEDs is about 2.7V), the total power consumption of the backlight can be calculated: 4.8 mA×21.6V=103.68 mW. By contrast, in the same circuit structure, the power consumption of the brightness control method of the present embodiment disclosed 103.68 mW is much lower than the power consumption of the conventional brightness control method 124.8 mW, it is possible to reduce the power consumption by using the brightness adjustment method disclosed in the present embodiment.

If the average brightness is not less than the preset brightness, the controller 220 is further configured to adjust the current of each LED light string 210, so that the brightness of the multi-string LED light string 210 in parallel provided is satisfied the brightness of all pixels 110 displaying image required.

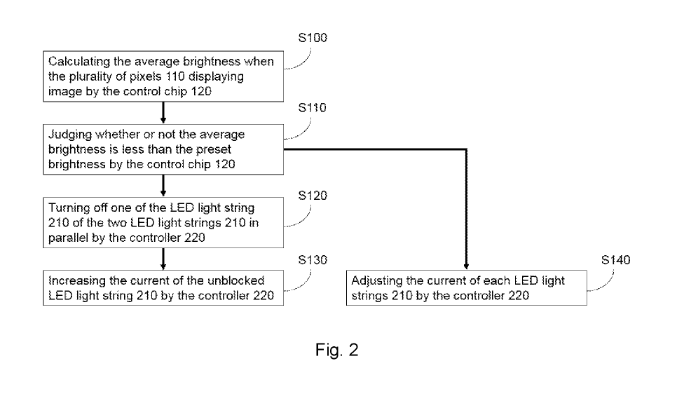

FIG. 2 is a flow chart of the method for lowering power consumption of liquid crystal display of the embodiment of the present disclosure.

Please refer to FIG. 1 and FIG. 2, in the step S100, calculating the average brightness when the plurality of pixels 110 displaying image by the control chip 120. Here, the average brightness refers to the ratio of the sum of the brightness displaying the image and the number of all pixels 110.

In the step S110, comparing the average brightness with the preset brightness by the control chip 120. If the average brightness is less than the preset brightness, the step S120 and the step S130 are performed. If the average brightness is less than the preset brightness, the step S140 is performed.

In the step S120, turning off one of the LED light string 210 of the two LED light strings 210 in parallel by the controller 220. Here, when the number of the LED light string 210 is three or more, turning off at least one LED light string 210 of the multi-string LED light string 210 in parallel.

In the step S130, increasing the current of the unblocked LED light string 210 by the controller 220, so that the brightness of the unblocked LED light string 210 provided is satisfied the brightness of the plurality of pixels 110 displaying image required.

Specifically, after one of the LED light string 210 of the two LED light strings 210 in parallel turned off, determining the current of the unblocked LED light string 210 required according to the brightness of the plurality of pixel 110 displaying image required by the control chip 120, here, the current of the unblocked LED light string 210 required is greater than the current when the two LED light strings 210 are opened.

Finding the corresponding control signal by the control chip 120 from the lookup table of the external system 300 based on the determined current of the unblocked LED light string 210 required, and outputting the control signal searched by the control chip 120 to the controller 220. In the present embodiment, the control signal may be, for example, a logic level signal.

Increasing the current of the unblocked LED light string 210 controlled by the controller 220 according to the outputted control signal, so that the current of the unblocked LED light string 210 reaches the required current. Here, since the duty ratio of the detected control signal is increased, increasing the current of the unblocked LED light string 210 by the controller 220 according to the control signal in which the duty ratio is increased.

In the step S140, adjusting the current of each LED light strings 210 by the controller 220, so that the brightness of the multi-string LED light string in parallel 210 provided is satisfied the brightness of all pixels 110 displaying image required.

As described above, according to the embodiments of the present disclosure, the power consumption of the backlight module can be reduced without affecting the screen display effect, so that the power saving effect can be achieved.

Although reference to particular embodiments shown and described the present disclosure, those skilled in the art will understand: without departing from the spirit and scope of the appended claims and their equivalents of the present disclosure, a case, in this that various changes in form and details.

What is claimed is:

1. A method for lowering power consumption of liquid crystal display, wherein, comprises:
calculating an average brightness of all pixels when displaying the image;
comparing the average brightness with a preset brightness;
determining whether at least one string in the multi-string LED light string in parallel is turned off according to the comparison result.

2. The method for lowering power consumption of liquid crystal display according to claim 1, wherein, if the average brightness is less than the preset brightness, turning off at least one string of the multi-string LED light string in parallel.

3. The method for lowering power consumption of liquid crystal display according to claim 2, wherein, after turning off the at least one string of the multi-string LED light string in parallel, increasing the current of the LED light string that is not turned off so that the brightness of the unblocked LED light string provided is satisfied the brightness of all pixels displaying the image required.

4. The method for lowering power consumption of liquid crystal display according to claim 3, wherein, the method of increasing the current of the unblocked LED light string comprises:
determining the current of the unblocked LED light string required according to the brightness of all pixels displaying image required;
outputting a control signal according to the current of the unblocked LED light string required;
increasing the current of the unblocked LED light string according to the outputted control signal, so that the current of the unblocked LED light string reaches the required current.

5. The method for lowering power consumption of liquid crystal display according to claim 1, wherein, if the average brightness is not less than the preset brightness, adjusting the current of each LED light string, so that the brightness of the multi-string LED light string in parallel provided is satisfied the brightness of all pixels displaying image required.

6. The method for lowering power consumption of liquid crystal display according to claim 2, wherein, if the average brightness is not less than the preset brightness, adjusting the current of each LED light string, so that the brightness of the multi-string LED light string in parallel provided is satisfied the brightness of all pixels displaying image required.

7. The method for lowering power consumption of liquid crystal display according to claim 3, wherein, if the average brightness is not less than the preset brightness, adjusting the current of each LED light string, so that the brightness of the multi-string LED light string in parallel provided is satisfied the brightness of all pixels displaying image required.

8. The method for lowering power consumption of liquid crystal display according to claim 4, wherein, if the average brightness is not less than the preset brightness, adjusting the current of each LED light string, so that the brightness of the multi-string LED light string in parallel provided is satisfied the brightness of all pixels displaying image required.

9. A liquid crystal display, comprises a liquid crystal panel and a backlight module arranged in opposing relation, the liquid crystal panel comprises a plurality of pixels and a control chip, the backlight module comprises the multi-string LED light string in parallel and a controller used to control the LED light string, the control chip is used to receive a image data from an external system, the plurality of pixels is used to display image based on the image data and provided by the multi-string LED light string in parallel, wherein, when the plurality of pixels displaying image, the control chip is further used to calculate the average brightness when the plurality of pixels displaying image, and further comparing the average brightness with the preset brightness; the controller is further used to determine whether at least one string in the multi-string LED light string in parallel is turned off according to the comparison result.

10. The liquid crystal display according to claim 9, wherein, if the average brightness is less than the preset brightness, the controller is further used to turn off at least one string in the multi-string LED light string in parallel.

11. The liquid crystal display according to claim 10, wherein, the controller is further used to increase the current of the unblocked LED light string, so that the brightness of the unblocked LED light string provided is satisfied the brightness of all pixels displaying image required.

12. The liquid crystal display according to claim 11, wherein, the control chip is further used to determine the current of the unblocked LED light string required according to the brightness of all pixels displaying image required, and is further used to output the control signal according to the current of the unblocked LED light string required; the controller is further used to increase the current of the unblocked LED light string according to the outputted control signal, so that the current of the unblocked LED light string reaches the required current.

13. The liquid crystal display according to any one of claim 9, wherein, if the average brightness is not less than the preset brightness, the controller is further used to adjust the current of each LED light string, so that the brightness of the multi-string LED light string in parallel provided is satisfied the brightness of all pixels displaying image required.

14. The liquid crystal display according to any one of claim 10, wherein, if the average brightness is not less than the preset brightness, the controller is further used to adjust the current of each LED light string, so that the brightness of the multi-string LED light string in parallel provided is satisfied the brightness of all pixels displaying image required.

15. The liquid crystal display according to any one of claim 11, wherein, if the average brightness is not less than the preset brightness, the controller is further used to adjust the current of each LED light string, so that the brightness of the multi-string LED light string in parallel provided is satisfied the brightness of all pixels displaying image required.

16. The liquid crystal display according to any one of claim 12, wherein, if the average brightness is not less than the preset brightness, the controller is further used to adjust the current of each LED light string, so that the brightness of the multi-string LED light string in parallel provided is satisfied the brightness of all pixels displaying image required.
